(19) United States
(12) Patent Application Publication
(10) Pub. No.: US 2013/0213877 A1
(43) Pub. Date: Aug. 22, 2013

(54) FLUID FILTER AND FILTER CARTRIDGE

(71) Applicants: Shin-Wei Lin, Linkou (TW); Sheng-Nan Lin, Pingtung City (TW)

(72) Inventors: Shin-Wei Lin, Linkou (TW); Sheng-Nan Lin, Pingtung City (TW)

(73) Assignee: 3M INNOVATIVE PROPERTIES COMPANY, ST.Paul, MN (US)

(21) Appl. No.: 13/642,443

(22) PCT Filed: Apr. 21, 2011
(86) PCT No.: PCT/US11/33428

§ 371 Date: May 3, 2013

(30) Foreign Application Priority Data
Apr. 21, 2010 (CN) 201010167422.X

(51) Int. Cl. B01D 27/14

(52) U.S. Cl. CPC B01D 27/148
USPC 210/338

(57) ABSTRACT

A fluid filter (1) includes an outer jug (11), an inner jug (12) and a filter cartridge (3); the inner jug (12) is installed at the top of the outer jug (11), and the filter cartridge (3) is installed in the bottom of the inner jug through the engagement of the protruding rib (35) of the filter cartridge and the fixing components (125) of the inner jug. The filter cartridge (3) may comprise an inner cavity (33) filled with a first filtering material and an outer cavity (34) filled with a second filtering material, such that when water flows into the filter cartridge (3), the water will flow through the first filtering material of the inner cavity (33) and the second filtering material of the outer cavity (34) in succession, thereby allowing the water that flows through the filter cartridge (3) to be filtered twice.

### BACKGROUND

The present invention relates to a fluid filter and filter cartridge and, more particularly, to a water filter pitcher including a filter cartridge that contains more than one type of filtration media.

Tap water in homes is often supplied from water towers, and if the water towers are not cleaned regularly, the tap water may contain foreign materials such as sand, bacteria, algae, and heavy metals. If the tap water does not undergo proper treatment or filtering procedures, the water may have negative effects on personal health after long-term drinking. In order to satisfy the need to filter tap water in the home, people in the past mostly have used an entire set of filtering equipment. Such equipment, however, is not easy to install, and the costs are high.

Another approach to filter tap water in the home is to use water fluid filters, such as water pitchers or jugs, that take up little space and are easy to install and use to filter water, especially drinking water. Conventional water filter jugs on the market, however, use filter cartridges with only a single filtering material, and therefore filter the tap water only one time. As a result, water filtered by such a water filter jug still contains the aforementioned foreign materials that the single filter material of the filter cartridge cannot filter, causing one to worry that there is no way to obtain pure, filtered water. Furthermore, in the structure of most water filter jugs on the market, the technique of combining the inner shell and filter cartridge causes a gap to remain between the two, thereby allowing water that has not been filtered by the filter cartridge to flow into the outer jug of the water filter jug, thereby contaminating the filtered water.

In the filter cartridge 7 published in U.S. Patent Publication No. US2008/0264853 shown in FIG. 1, for example, the filter cartridge 7 has only a single filtering material 72. As a result, when the water waiting to be filtered passes through the inlet 71 of the filter cartridge 7, the water is only filtered by the filtering material 72 and then is discharged from the outlet 73 of the filter cartridge 7. In addition, the single filtering material 72 indicated in Patent Publication No. US2008/0264853 can be activated carbon or ion exchange resin, and here, if the single filtering material 72 is only one of the two aforementioned filtering materials, the water filtered by the filter cartridge 7 can only filter out the foreign materials that can be filtered by activated carbon or ion exchange resin, and the other foreign materials that cannot be filtered by activated carbon or ion exchange resin remain in the water. Consequently, the filtering capability of the filter cartridge 7 is limited.

Furthermore, U.S. Patent Publication No. US2008/0264853 discloses combining the filter cartridge 7 and the water filter jug 9 (as shown in FIG. 2). The water filter jug 9 has an outer jug 91 and an inner jug 92, and the filter cartridge 7 is located in an installation indentation 921 in the base of the inner jug 91. In use, a user pours unfiltered water into the inner jug 92 of the water filter jug 9, and the water flows from the inner jug 92 into the filter cartridge 7 in the installation indentation 921 in the base of the inner jug 92, is filtered by the filter cartridge 7, and then flows into the outer jug 91. However, the filter cartridge 7 is directly placed in the installation indentation 921 in the inner jug 92, and there will be a certain space between the filter cartridge 7 and the inner wall of the installation indentation 921, and here, a small amount of the water in the inner jug 92 may pass through the space and flow into the outer jug 91 without passing through the filter cartridge 7. As a result, the water that does not pass through the filter cartridge 7 but flows into the outer jug 92—unfiltered—and mixes with the filtered water, thereby causing a decrease in the filtering effectiveness of the water filter jug 9.

### SUMMARY

As such, the need exists for a filter cartridge that can have two kinds of filtering materials, thereby to allow liquid (e.g.: tap water) poured into the liquid filter to be filtered twice. The need also exists for a fluid filter having a structure that can avoid contamination of filtered water by unfiltered water flowing into the filtered water.

In one aspect, the present invention provides filter cartridge that has two kinds of filtering materials, so that fluids that pass through the filter cartridge can be filtered twice. More particularly, the invention provides a filter cartridge that can effectively and sufficiently filter the fluids that pass through the filter cartridge, thereby providing water that is more pure.

In another aspect, the invention provides a fluid filter with a structure that prevents fluids that have not passed through the filter cartridge from flowing into the filtered fluids and contaminating the filtered fluids.

In order to realize the aforementioned features and benefits, the invention provides a fluid filter comprising an outer jug, inner jug and filter cartridge; the inner jug is installed in the top of the outer jug, and the filter cartridge is installed in the bottom of the inner jug through the engagement of the protruding rib of the filter cartridge and the fixing components of the inner jug; the filter cartridge inlet connects with the inner jug, and the filter cartridge outlet connects with the outer jug; when water is poured into the fluid filter, the water passes through the inner jug inlet and flows into the inner jug, then it passes through the filter cartridge inlet and flows into the filter cartridge, then it passes through the filter cartridge outlet and flows into the outer jug. Furthermore, the filter cartridge comprises an inner cavity filled with the first filtering material and an outer cavity filled with the second filtering material; when water flows into the filter cartridge, the water will successively flow through the first filtering material in the inner cavity then the second filtering material in the outer cavity, thereby causing the water that flows through the filter cartridge to be filtered twice.

The following drawings and detailed description of the preferred embodiments is hereby provided so that those skilled in the art may better understand the technical features of the invention and as a basis for realizing the embodiments. The description is only used to describe the preferred embodiments of the invention, and is not limited to any form of the invention, and any revisions or changes made in the spirit of the invention shall fall within the scope claimed by the invention.

### BRIEF DESCRIPTION OF THE DRAWINGS

FIG. 1 is a cross-section of the filter cartridge according to the prior art;

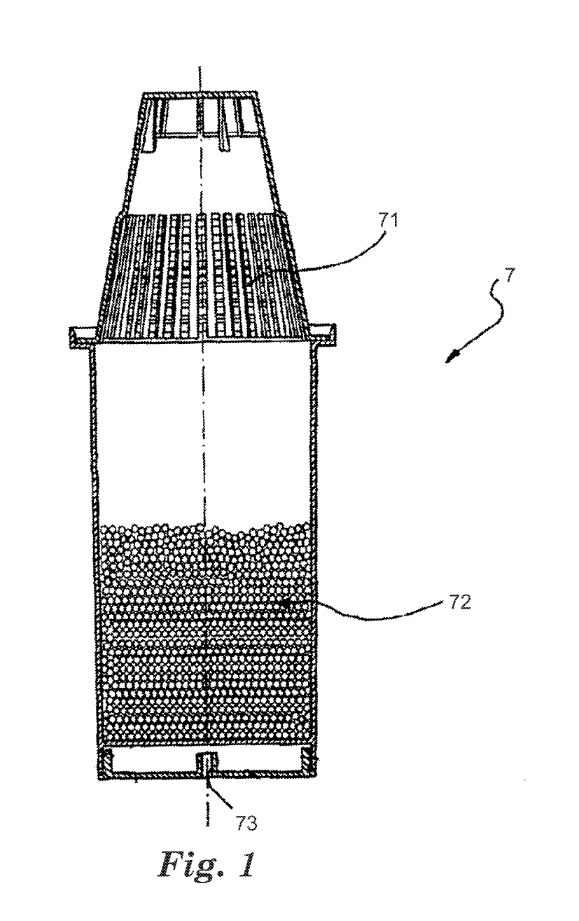

FIG. 2 is a schematic diagram of the water filter jug according to the prior art;

FIG. 3 is a three-dimensional drawing of the water filter jug of the present invention;

FIG. 4 is a cross-section of the filter cartridge of the present invention;

FIG. 5A is a three-dimensional drawing of the inner jug and filter cartridge of the present invention; and

FIG. 5B is a cross-section of the inner jug combined with the filter cartridge of the present invention.

### DETAILED DESCRIPTION

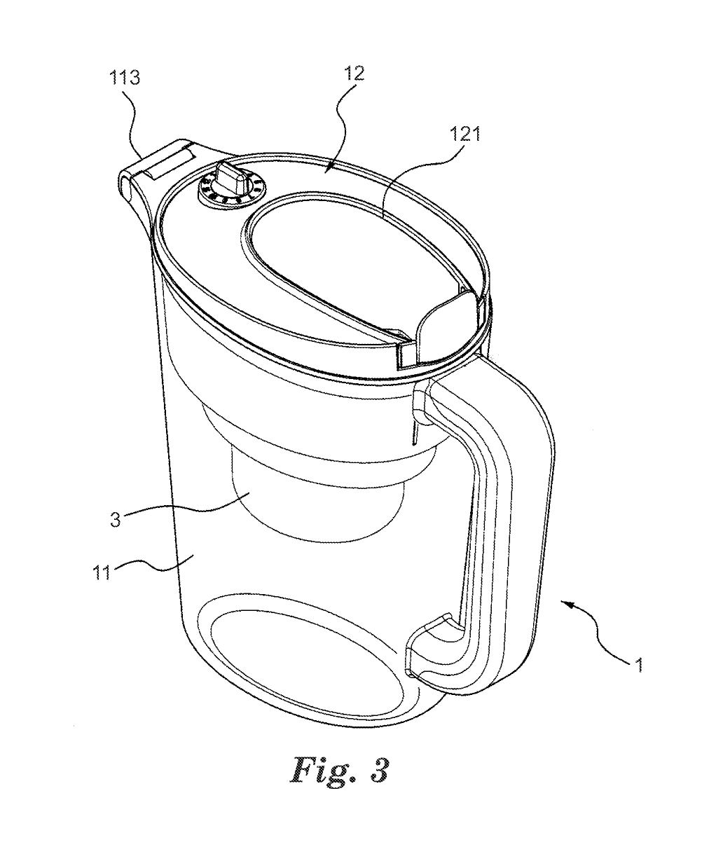

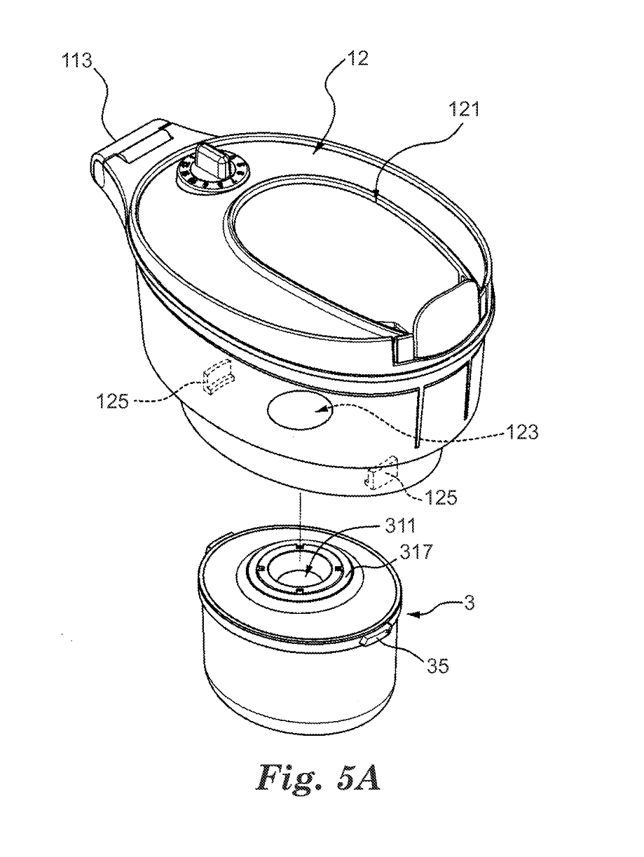

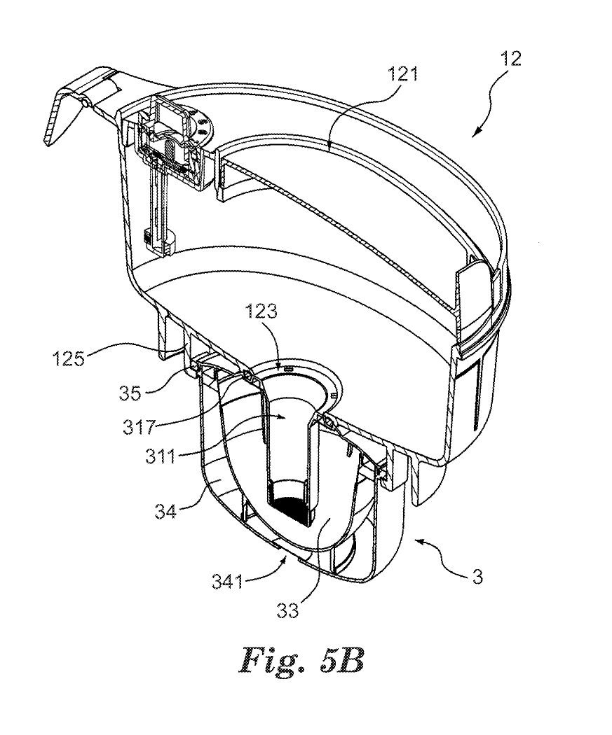

As shown in FIG. 3, in one embodiment the fluid filter 1 of the present invention (water filter jug 1 in the present embodiment) has an outer jug 11, an inner jug 12, and a filter cartridge 3. The outer jug 11 has an outlet 113, the top of the outer jug 11 is open, and the inner jug 12 is installed on the top of the outer jug 11 and fits into the open top of the outer jug 11. The inner jug 12 has an inlet 121 and outlet 123 (see FIGS. 5A and 5B), and the body of the inner jug 12 that contains water is placed in the outer jug 11. The filter cartridge 3 used in the water filter jug 1 is installed in the outer jug 11 of the water filter jug 1, and installed on the outside of the inner jug 12. The user can pour water to be filtered into the inner jug 12 through the inlet 121 of the inner jug 12, the water poured into the inner jug 12 then passes through the outlet 123 and flows into the filter cartridge 3, and flows into the outer jug 11 after being filtered by the filter cartridge by passing through the filter cartridge 3. When the user wishes to use the filtered water in the water filter jug, the user can obtain the water that has been filtered through the filter cartridge 3 and passed into the outer jug 11 from the outlet 113 of the outer jug.

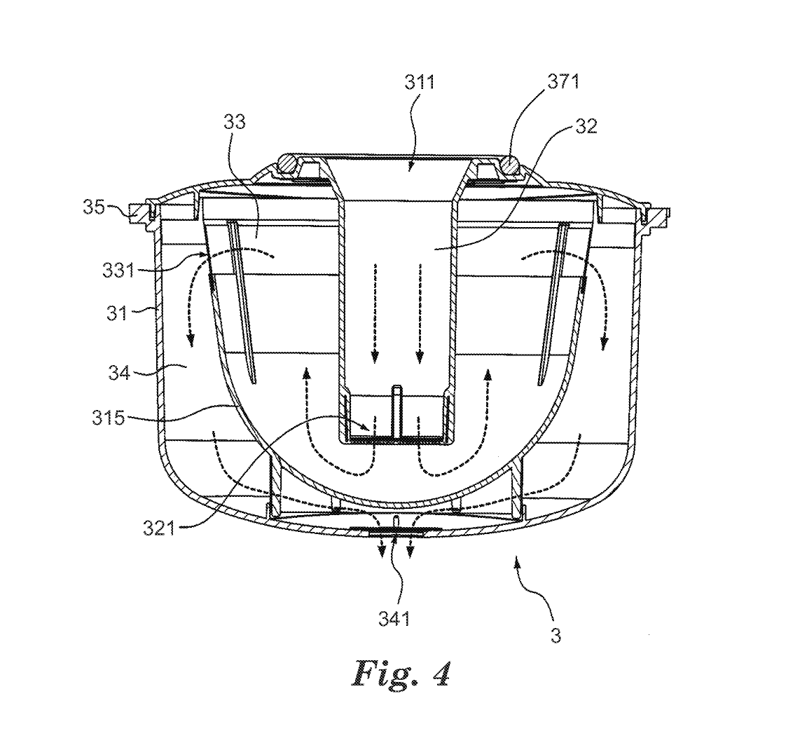

FIG. 4 is a cross-section of the filter cartridge of the present invention. In the illustrated embodiment, the filter cartridge 3 generally includes an outer shell 31, a hollow intake component 32, an inner cavity 33 filled with a first filtering material, and an outer cavity 34 filled with a second filtering material.

The hollow intake component 32 is located in the outer shell 31, and connects with the inlet 311 on the top of the outer shell 31. Water may be poured in through the inlet 311 and enter the filter cartridge 3 by passing through the intake component 32. The hollow intake component 32 has an outlet 321. The outlet 321 is located on one side of the hollow intake component 32, the side corresponds to the other side from where the hollow intake component 32 and inlet 311 connect, and is near the base of the inner cavity 33.

The outer shell 31 has a wall 315, and the wall 315 is formed by extending from the inside of the outer shell 31 and surrounding and covering the hollow intake component 32. As such, the inner cavity 33 is arranged between the outer surface of the intake component 32 and outer shell 31 and the inner surface of the wall 315, and the outer cavity 34 is arranged between the outer shell 31 and outer surface of the wall 315.

The inner cavity 33 fluidly connects to the outlet 321 of the hollow intake component 32, and its interior is filled with the first filtering material that can filter out foreign materials in the water. The inner cavity 33 has at least one outlet 331 formed in the wall 315, and the outlet 331 location may be also installed with a filter screen (not shown). The position of the outlet 331 is approximately near the top of the inner cavity 33.

The outer cavity 34 connects with the outlet 331 of the inner cavity 33, and its interior is filled with the second filtering material that can filter out foreign materials in the water, and the second filtering material is different from the first filtering material in the inner cavity 33. The outer cavity 34 has at least one outlet 341 formed in the outer shell 31, and the outlet 341 may also be installed with a filter screen (not shown). The position of the outlet 341 is located near the base of the outer cavity 34. Furthermore, the outlet 341 of the outer cavity 34 connects with the outer shell 11 of the water filter jug 1.

The first filtering material and second filtering material are not limited and may be, for example, activated carbon, ion exchange resin, process media such as those available from KDF Fluid Treatment, Inc., Three Rivers, Mich., or other filtering material that can filter out bacteria and/or other foreign materials and impurities from water.

When water to be filtered is poured into the filter cartridge 3 from the inlet 311 of the filter cartridge outer shell 31, the hollow intake component 32 guides the water through the outlet 321 into the inner cavity 33. The water then flows into the inner cavity 33 passes through the first filtering material in the inner cavity 33. The first filtering material in the inner cavity 33 performs the first filtering of the water. Then, the water that has been filtered one time flows through the outlet 331 of the inner cavity 33 into the outer cavity 33. After the water flows into the outer cavity 34, it passes through the second filtering material in the outer cavity 34, and the second filtering material in the outer cavity 34 performs the second filtering of the water. Next, the water that has been filtered twice in the filter cartridge 3 flows out of the outlet 341 of the outer cavity.

In one embodiment, the first and second filtering materials may be different filtering materials with different filtering functions, therefore the water filtered in the filter cartridge 3 passes through the first and second filtering materials, which can filter out different foreign materials in the water, achieving better filtering results.

In the embodiment illustrated in FIG. 4, the positions of the outlet 321 of the hollow intake component 32, the outlet 331 of the inner cavity 33, and the outlet 341 of the outer cavity are at different heights. That is, the position of the outlet 321 of the hollow intake cavity 32 is near the base of the inner cavity 33, the position of the outlet 331 of the inner cavity 33 is near the top of the inner cavity 33, and the position of the outlet 341 of the outer cavity 34 is near the base of the outer cavity 34. Arranged in this manner, the positioning of the above outlets causes water poured into the filter cartridge 3 to flow from the outlet 321 of the intake component 32 into the inner cavity 33 and pass through the first filtering material. The path the water takes from the outlet 331 of the inner cavity is longer than the path from the outlet 321 of the intake component 32 to the inner cavity 33 where it reaches any other place in the inner cavity 33. It also causes the water to flow from the outlet 331 of the inner cavity 33 into the outer cavity 34 and pass through the second filtering material. In addition, the path the water takes from the outlet 341 of the outer cavity 34 is longer than the path from the outlet 331 of the inner cavity 33 to the outer cavity 34 where it reaches any other place in the outer cavity 34 (see the directions of flow indicated by the arrows in FIG. 4). This flow pattern further causes the maximum contact time between the water and the filtering materials, thereby realizing more sufficient filtering. Therefore, the positions of the outlet 321 of the hollow intake component 32, outlet 331 of the inner cavity 33, and outlet 341 of the outer cavity 34 in the filter cartridge of the present invention lead to a route of maximum length for water flowing within the inner cavity 33, and a route of maximum length for water flowing within the outer cavity 34 in the filter cartridge 3, which causes the filter cartridge 3 of the present invention to reach maximum filtering efficiency.

Furthermore, the inner cavity 33 of the filter cartridge 3 of the present invention surrounds the hollow intake component 32, and the outer cavity 34 surrounds the inner cavity 33. This structure causes the first filtering material in the inner cavity 33 and second filtering material in the outer cavity 34 to have a more uniform area of contact with the water that flows through the filtering materials, and this increases the filtering efficiency of the filter cartridge of the present invention.

FIGS. 5A and 5B show the structural relationship between the inner jug 112 and filter cartridge 3. As shown in FIGS. 5A and 5B, the inner jug 12 has an inlet 121 and outlet 123. Two fixing components 125 are formed on the outer surface of its base. The filter cartridge 3 also has two protruding ribs 35 around its external surface and near the top of the outer shell 31, and a rubber ring for the inlet 311 around the top of the outer shell 31.

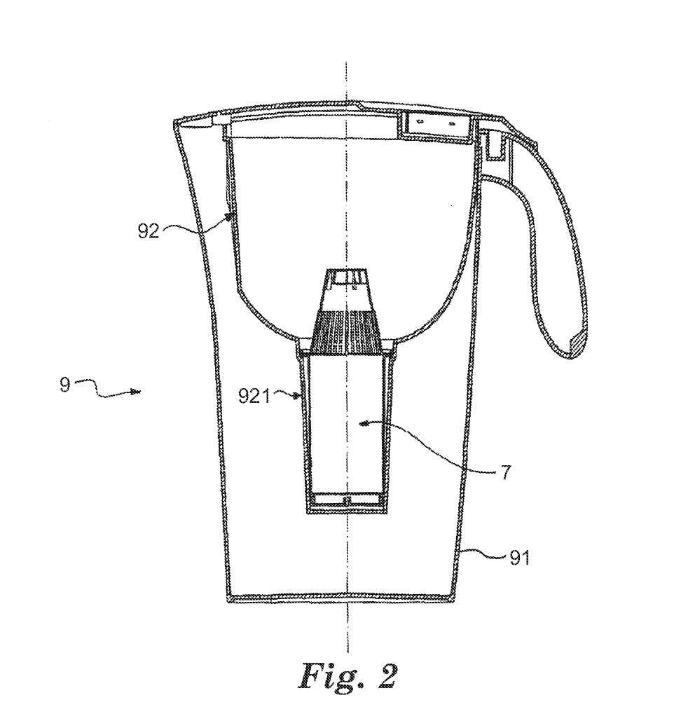

The inner jug 12 engages with the protruding ribs 35 of the filter cartridge through the fixing components 125 formed on its base, causing the filter cartridge 3 to combine with the inner jug 12, and be installed on the bottom of the inner jug 12. When the inner jug 12 and filter cartridge 3 are combined with one another, the outlet 123 of the inner jug 12 matches up with and connects to the inlet 311 of the filter cartridge 3, thereby causing the water to be filtered that is poured into the inlet 121 of the inner jug 12 to flow from the outlet 123 of the inner jug 12 into the inlet 311 of the filter cartridge 3, and then flow into the filter cartridge 3 to be filtered. The water that is filtered by the filter cartridge 3 flows from the outlet 341 of the outer cavity 34 of the filter cartridge 3 into the outer jug 11 of the water filter jug 1, and is stored in the outer jug 11. This method of combination can ensure that the water to be filtered in the inner jug 12 will completely flow into the filter cartridge 3, and that no unfiltered water will flow into the outer jug 91 without being filtered as can occur with conventional water filter jugs such as the water filter jug 9 shown in U.S. Patent Publication US2008/0264853 (shown in FIG. 2). Furthermore, the rubber ring 317 on the top of the outer shell 31 of the filter cartridge 3 that surrounds the inlet 311 of the filter cartridge 3 can further provide a seal when the filter cartridge 3 meets the inner jug 12.

The aforementioned embodiments can also be slightly revised in the spirit of the invention; for example, the intake component is not necessary. Also, the external appearances (e.g. size and shape) of the outer jug, the inner jug, and the filter cartridge may be different. In addition, how the inner and outer jugs are combined may be different. Such variations are considered to be within the spirit of the present invention may not depart from the spirit and major features of the present invention. Therefore, all aspects of the above embodiments shall be regarded as illustrative and not restrictive, and all changes that conform to the meaning and scope of the claims or that are equally valid, shall be included within the scope of the present invention.

1-12. (canceled)

13. A filter cartridge, comprising:
an outer shell, the outer shell having a top containing an inlet;
a hollow intake component arranged in the outer shell and in fluid communication with the inlet, the intake component having at least one outlet, thereby causing the fluid to flow from the inlet into the intake component, and passing through the outlet, thereby flowing out of the intake component;
a wall extending from the outer shell and surrounding the intake component, thereby delineating an inner cavity between the outer surface of the inlet component and the outer shell and inner surface of the wall, and delineating an outer cavity between the outer shell and outer surface of the wall;
the inner cavity being filled with a first filtering material, and being in fluid communication with the outlet of the intake component, and being installed on at least one of the outlets of the wall, thereby causing the fluid in the intake component to flow into the inner cavity from the outlet of the intake component, and flow out of the outlet of the inner cavity;
the outer cavity being filled with a second filtering material, and being in fluid communication with the outlet of the inner cavity, and being installed on at least one of the outlets of the outer shell, thereby causing the fluid in the inner cavity to flow into the outer cavity from the outlet of the inner cavity, and flow out of the outlet of the outer cavity;
wherein the position of the outlet of the intake component and the position of the outlet of the inner cavity are at different heights, and the position of the outlet of the inner cavity is at a different height than the position of the outlet of the outer cavity.

2. A filter cartridge, comprising:
an outer shell, the outer shell having a top containing an inlet;
a hollow intake component installed in the outer shell and connected with the inlet, the intake component having at least one outlet, thereby causing the fluid to flow from the inlet into the intake component, and pass through the outlet, thereby flowing out of the intake component;
a wall extending from the outer shell and surrounding the intake component, thereby delineating an inner cavity between the outer surface of the inlet component and an outer shell and inner surface of the wall, and delineating an outer cavity between the outer shell and outer surface of the wall;
wherein the inner cavity is filled with a first filtering material and connects with the outlet of the intake component, and is installed on at least one of the outlets of the wall, thereby causing the fluid in the intake component to flow into the inner cavity from the outlet of the intake component, and flow out of the outlet of the inner cavity;
wherein the outer cavity is filled with a second filtering material and connects with the outlet of the inner cavity, and is installed on at least one of the outlets of the outer shell, thereby causing the fluid in the inner cavity to flow into the outer cavity from the outlet of the inner cavity, and flow out of the outlet of the outer cavity; and
and wherein the position of the outlet of the inner cavity causes the path of fluid flowing from the outlet of the intake component to the outlet of the inner cavity to be longer than the path of the fluid flowing from the outlet of the intake component to any place within the inner cavity, and the position of the outlet of the outer cavity causes the path of fluid flowing from the outlet of the inner cavity to the outlet of the outer cavity to be longer than the path of the fluid flowing from the outlet of the inner cavity to any place within the outer cavity.

3. A filter cartridge according to claim 1, wherein an outlet of the intake component is located near the base of the inner cavity, the outlet of the inner cavity is located near the top of the inner cavity, and the outlet of the outer cavity is located on the base of the outer cavity.

4. A filter cartridge, comprising:
an outer shell, the outer shell having a top containing an inlet;
a hollow intake component installed in the outer shell and connecting with the inlet, the intake component having at least one outlet, thereby causing the fluid to flow from the inlet into the intake component, and pass through the outlet, thereby flowing out of the intake component;
a wall extending from the outer shell, and delineates an inner cavity between the outer shell and inner surface of the wall, and delineates an outer cavity between the outer shell and outer surface of the wall;
wherein the inner cavity is filled with a first filtering material and connects with the inlet, and is installed on at least one of the outlets of the wall, thereby causing the fluid to flow from the inlet into the inner cavity, then flow out of the outlet;
wherein the outer cavity is filled with a second filtering material and connects with the outlet of the inner cavity, and is installed on at least one of the outlets of the outer shell, thereby causing the fluid in the inner cavity to flow into the outer cavity from the outlet of the inner cavity, and flow out of the outlet of the outer cavity; and
wherein the position of the outlet of the inner cavity causes the path of fluid flowing from the inlet to the outlet of the inner cavity to be longer than the path of the fluid flowing from the inlet to any place within the inner cavity, and the position of the outlet of the outer cavity causes the path of fluid flowing from the outlet of the inner cavity to the outlet of the outer cavity to be longer than the path of the fluid flowing from the outlet of the inner cavity to any place within the outer cavity.

5. A filter cartridge according to claim 1, further having a mesh installed on the outlet of the inner cavity.

6. A filter cartridge according to claim 1, further having a mesh installed on the outlet of the outer cavity.

7. A filter cartridge according to claim 1, wherein the first filtering material is the same as the second filtering material.

8. A filter cartridge according to claim 1, wherein the first filtering material is different from the second filtering material.

9. A filter cartridge according to claim 1, wherein the fluid is water.

10. The filter cartridge according to claim 1, further having at least two protruding ribs formed around the outside of the outer shell and near the top of the outer shell, wherein the filter cartridge is installed in the base of the inner jug by the engagement of the protruding rib of the filter cartridge and the fixing components of the inner jug, the inlet of the filter cartridge connects to the outlet of the inner jug, and the outlet of the outer cavity connects to the outer jug.

11. A fluid filter, comprising:
an outer jug having an open top and outlet;
an inner jug that fits into the open top of the outer jug, the inner jug having an inlet on its top and outlet on its base, and wherein there are at least two fixing components formed on the outer surface of its base.

12. A fluid filter according to claim 11, further having a rubber ring disposed on the top of the outer shell of the filter cartridge and surrounding the inlet of the filter cartridge.
